(19) United States
(12) Patent Application Publication
(10) Pub. No.: US 2011/0048284 A1
(43) Pub. Date: Mar. 3, 2011

(54) Manufacturing method of modified powder

(75) Inventors: Jae-Young Choi, Ansan City (KR); Byoung-Chul Kim, Ansan City (KR)

(73) Assignee: SUNJIN CHEMICAL Co., Ltd., Ansan City (KR)

(21) Appl. No.: 12/556,627

(22) Filed: Sep. 10, 2009

(30) Foreign Application Priority Data
Aug. 26, 2009 (KR) 10-2009-0079268

(51) Int. Cl. C04B 14/20; C09C 1/02; B05D 3/12

(52) U.S. Cl. 106/417; 106/469; 427/242

(57) ABSTRACT

The present invention relates to a method for manufacturing modified powder, particularly to a method for dry manufacturing of modified powder comprising the steps of: a) dry mixing powder having hydroxyl group (—OH) at the end and lauroyl lysine in a reactor equipped with an agitator; and, b) agitating the reactor to coat lauroyl lysine on the surface of the powder.

### CROSS-REFERENCE TO RELATED APPLICATION

This application claims priority to and the benefit of Korean Patent Application No. 10-2009-0079268 filed in the Korean Intellectual Property Office on Aug. 26, 2009, the entire content of which is incorporated herein by reference.

### BACKGROUND OF THE INVENTION

(a) Field of the Invention

The present invention relates to a method for manufacturing modified powder, particularly to a method for manufacturing modified powder using lauroyl lysine by dry process instead of wet process, and a cosmetic composition comprising modified powder obtained thereby.

(b) Description of the Related Art

In general, materials such as a pigment, an emulsions, water, etc. are used in cosmetics, and the mixing ratio thereof or used materials are varied depending on the use purpose. Most commonly used material in cosmetics is pigment powder, which is used for expressing unique color of make-up or making up the skin defect. Such pigment is classified into an inorganic pigment and an organic pigment, and, for expressing skin color, an inorganic pigment is used, and only for expressing color of specific part, an organic pigment and an inorganic pigment are appropriately combined.

Inorganic pigments used in cosmetics include a pure inorganic pigment, an extender pigment, mica titania, etc. Specifically, a pure inorganic pigment has high pigment contents and determines color series and lightness, and includes titanium dioxide, iron oxide such as yellow iron oxide or black iron oxide, dark blue, navy blue, etc. An extender pigment has low pigment contents and assists in expressing color of a pure inorganic pigment or improves texture and physical properties, and includes an inorganic extender pigment such as talc, mica (white mica, black mica), sericite, kaolin, silica, calcium carbonate, iron oxide, etc. and an organic extender pigment such a nylon-6, nylon-12, cellulose powder, acryl powder, etc. And, a pigment having special optical effect of pearl is used for delivering pearl luster, iris color or metallic pigment.

Various studies for improving texture of the powder used in cosmetics for eye or face have been progressed for a long time. A general approach is to treat the surface of main pigment in preparation. For the surface treatment, an inorganic pigment is coated with N-monoacylated basic amino acid (for example, N-lauroyl-L-lysine) having long chain acyl group, which is conducted by a wet process wherein all materials are mixed in solution to react in a liquid phase, dehydrated, and dried. However, the wet process of the prior art requires separate dehydration and drying processes, and addition of catalyst or neutralization by acid-base, and it is not suitable for continuous process, thus the process is complicated and requires many equipments to decrease productivity.

### SUMMARY OF THE INVENTION

In order to overcome the problems of the prior art, it is an object of the invention to provide a method for manufacturing modified powder by dry coating lauroyl lysine, which does not require separate dehydration and drying processes and additional equipments other than a powder mixer, can be conducted under normal conditions such as PFR or CSTR as well as in a batch reactor that is used in the existing wet process, does not require separate catalyst or acid-base neutralization, and, comparing with the existing wet process under the same equipment conditions, shows remarkable increase in productivity and decrease in production time.

It is another object of the invention to provide a cosmetic composition comprising the modified powder obtained by the above method.

In order to achieve the objects, the present invention provides a method for dry manufacturing of modified powder comprising the steps of: a) dry mixing powder having hydroxyl group (—OH) at the end and lauroyl lysine in a reactor equipped with an agitator; and, b) agitating the reactor to coat lauroyl lysine on the surface of the powder.

The present invention also provides modified powder manufactured by the above method.

The present invention also provides a cosmetic composition comprising the modified powder.

According to the invention, since lauroyl lysine coated modified powder that has been prepared only by a wet process in the prior art can be prepared by a dry process, a separate dehydration and drying processes are not required and additional equipments other than a powder mixer are not required. And, the process can be conducted under normal conditions such as PFR or CSTR as well as in a batch reactor that is used in wet process, and it does not require a separate catalyst or acid-base neutralization. Moreover, comparing with the existing wet process under the same equipment conditions, remarkable increase in productivity and decrease in production time can be obtained.

### BRIEF DESCRIPTION OF THE DRAWINGS

FIG. 1 shows SEM photo of modified powder (MICA-LL) prepared in Example 1.

FIG. 2 shows photo of water repellency test result of modified powders (MICA-LL) prepared in Comparative Example and Example 1 of the invention.

### DETAILED DESCRIPTION OF THE EMBODIMENTS

The method for manufacturing modified powder of the invention comprises the steps of: a) dry mixing powder having hydroxyl group (—OH) at the end and lauroyl lysine in a reactor equipped with an agitator; and, b) agitating the reactor to coat lauroyl lysine on the surface of the powder.

The present invention will now be explained in detail.

As the powder, powder having hydroxyl (—OH) group at the end that is commonly used for a cosmetic composition can be used. The form of the powder includes particle powder, flake powder or a mixed powder thereof.

The particle size of the particle powder is not specifically limited, and can be optionally selected. For example, particle having size of 0.001-1000 um can be used. Preferably, particle of 0.001-100 um, more preferably 0.01-50 um can be used. Within the particle size of the above range, coatability and texture for cosmetics are good. A method for measuring average primary particle diameter includes measurement of particle diameter by scanning electron microscopy or transmission electron microscopy, and measurement using a particle size analyzer. Examples of the particle include titanium oxide particle, zinc oxide particle, and silica particle, etc.

As the flake powder in the present invention, powder that can inhibit cohesion of particle powders and increase dispersibility can be used without specific limitation. The flake powder includes lamellar powder and flaky powder. The thickness for long diameter is not specifically limited, and can be optionally selected. For example, powder having thickness of 0.001-1000 um can be used. Preferably, powder of 0.001-50 um can be used. Within the above range, it can effectively inhibit cohesion of particle powders, and uniformly disperse them. Examples of the flake powder may be selected one or more kinds from the group consisting of barium sulfate, silk powder, talc, mica, sericite, kaolin, titanium dioxide coated mica, iron oxide coated mica, chrome oxide coated mica, calcium carbonate, magnesium carbonate, aluminum silicate, magnesium sulfate and surface-treated powder thereof.

In case the flake powder and particle powder are mixed, the amount of the flake powder can be selected depending on the kind, size and shape of the powder, and preferably 2.5 to 50 parts by weight of the flake powders can be used, based on 100 parts by weight of the particle powders. Within the above range, transparency of modified powder can be sufficiently increased and texture thereof can be sufficiently smoothed while maintaining high adhesion of particle powder. In the present invention, the particle powder and flake powder, or a mixed powder thereof can be obtained by, for example, dry mixing them using a mixer, or by introducing them in a suitable solvent such as water, ethanol, etc. and agitating the solution, and then removing the solvent and drying and pulverizing the mixture.

As lauroyl lysine in the present invention, those commercially available can be used, and N-lauroyl-L-lysine and N-lauroyl-D-lysine can be used alone or in combination. In terms of the texture of prepared modified powder or material cost, N-lauroyl-L-lysine is preferable. The amount of lauroyl lysine is preferably 0.5 to 50 parts by weight, based on 100 parts by weight of the powders. Within the above range, modified powder can be sufficiently smoothed without inhibiting adhesion of powder to skin.

In the manufacturing method of modified powder of the present invention, a) powder having hydroxyl (—OH) group at the end and lauroyl lysine are dry mixed in a reactor equipped with an agitator. Specifically, a wet process wherein powder and lauroyl lysine are mixed in a solution state and reacted is not used, but a reaction proceeds by a dry process by mixing in a solid state or powder state. It should be understood that the reaction by a dry process in the present invention is not a simple physical mixing but a reaction by chemical bonding.

As the reactor, those capable of providing sufficient friction or heat through agitation so as to react powder and lauroyl lysine can be used without specific limitations. Preferably, the reactor is equipped with a heater so as to rapidly elevate a temperature inside the reactor. The agitator and heater can be equipped in the reactor, or separate apparatuses can be attached to the reactor. Examples of the reactor include Henschel mixer, Reactor dryer, other containers that can agitate powders, etc.

In the step a), pH inside the reactor can be optionally controlled. In the wet process of the prior art, coating is enabled only within a specific pH (4-6), but in the present invention, coating is enabled without controlling pH. And, if pH inside the reactor is maintained a t5-9, modified powder suitable for a cosmetic material can be prepared by only one process. In order to control pH of the prepared modified powder, if necessary, a pH control agent is introduced after introducing powder in a reactor. For example, in case mica is used as the powder and coated with lauroyl lysine, since pH of mica-lauroyl lysine exceeds the range that can be commonly used for a cosmetic composition, a pH control agent needs to be added. As the pH control agent, various acids usable for cosmetics, for examples, an organic acid or an inorganic acid, can be used. Examples of the organic acid include citric acid, fumaric acid, succinic acid, etc., and examples of the inorganic acid include nitric acid, hydrochloric acid, etc. Preferably, citric acid is used. For example, in case mica having pH of 9.4 and N-lauroyl-L-lysine having pH of 5.4 are reacted by a dry process, pH of 9 or more may be obtained, and thus, appropriate amount of an acid solution, etc. can be added in the mixing step to control pH within a range usable for a cosmetic composition. However, in case talc (pH 8.2), or sericite (pH 5.7), etc. is used as the powder, pH of the modified powder obtained by the reaction satisfies desirable pH range, and thus, a pH control agent needs not to be separately added.

In the step b), the reactor in which the powder, lauroyl lysine, and optionally, a pH control agent, are introduced are rotated and agitated. Preferably, the reactor is further equipped with a heater so as to rapidly elevate a temperature inside the reactor. Since reaction temperature may differ depending on the used materials, it is preferable to observe temperature or color and check water repellency or texture while agitating reactants at high speed. It is preferable to gradually elevate temperature from the initial mixing temperature to an appropriate temperature selected within 80 to 200° C., more preferably 80 to 150° C. Within the above reaction temperature range, water repellency of the prepared modified powder is very excellent. In the present invention, although melting point of lauroyl lysine is higher than the above temperature range (for example, in the case of N-lauroyl-L-lysine, about 230° C.), it is coated on the surface of powder by friction and heat generated in the mixing step. And, although specifically limited, agitation is conducted at 100 rpm or more, preferably 500-7000 rpm, and more preferably 500-3000 rpm. Within the above range, the prepared modified powder has excellent coatability, i.e., water repellency, and thus, when used for cosmetics, gives good texture.

According to the dry manufacturing method of modified powder of the present invention, water content of the obtained modified powder is commonly less than 0.5 wt %, and even if an acid solution is introduced in the step of mixing materials to control pH, water content does not exceed 2 wt %, and thus, a subsequent drying process is not required.

The modified powder obtained in the present invention can be used in a cosmetic composition. The amount of the modified powder in powder cosmetics can be controlled depending on the properties of the product, and preferably, 0.5 to 30 wt % of the modified powder is used, based on the total amount of the powder cosmetics. Within the above range, properties of cosmetics and texture can be simultaneously satisfied.

The cosmetics includes a powder foundation, white powder, face powder, an eyeshadow, pressed powder, a chick color, a liquid foundation, an oil foundation, a lipstick, etc. Especially, as powder cosmetics that can remarkably exhibit the effect of the present invention, a powder foundation, white powder, face powder, an eyeshadow, pressed powder, a powder type chick color, or other types thereof can be illustrated. In the powder cosmetics of the present invention, in addition to the modified powder, powders, a coloring agent, an emulsion, a moisturizer, a surfactant, a sterilizer, a fragrance, a solvent, salts, viscous material, polymer, an antiseptic, etc. commonly used in powder cosmetics can be simultaneously combined. The powders include inorganic powder, organic powder, a pigment of the prior art, and the mixed powder thereof, and surface-treated powders such as silicone-treated, fluorine compound-treated, metal soap-treated, emulsion-treated powders, etc. And, if necessary, the modified powder of the present invention can be further surface-treated by surface treatment method of the prior art.

The present invention will be explained with reference to the following examples. However, these are only to illustrate the invention, and the scope of the invention is not limited thereto and it is determined by the claims.

### Example 1

20 kg of Mica (MC0800, pH 9.4) were introduced into a Henschel mixer, and then, 0.0075 kg of a 5% citric acid aqueous solution was introduced therein and the mixture was sufficiently agitated to control pH thereof. 0.4 kg of N-lauroyl-L-lysine (AMIHOPE-LL, pH 5.4) was introduced, temperature was elevated to 80° C. while slowly adding steam, and the mixture was agitated at high speed (500-3000 rpm) to prepare N-lauroyl-L-lysine coated mica. During the agitation, temperature and color of the reactant were observed to check water repellency or texture. The pH of the final product was 6.8, and water content was 0.51 wt %. No waste water generated, and total time required for preparation was less than 10 hours.

### Example 2

20 kg of Mica (MC0800, pH 9.4) were introduced into a Henschel mixer, and then, 0.0075 kg of a 5% citric acid aqueous solution was introduced therein and the mixture was sufficiently agitated to control pH thereof. 0.4 kg of N-lauroyl-L-lysine (AMIHOPE-LL, pH 5.4) was introduced, temperature was elevated to 100° C. while slowly adding steam, and the mixture was agitated at high speed (500-3000 rpm) to prepare N-lauroyl-L-lysine coated mica. During the agitation, temperature and color of the reactant were observed to check water repellency or texture. The pH of the final product was 6.82, and water content was 0.50 wt %. No waste water generated, and total time required for preparation was less than 10 hours.

### Example 3

20 kg of talc (JA-46R, pH 8.2) were introduced into a Henschel mixer, 0.4 kg of N-lauroyl-L-lysine was introduced therein, temperature was elevated to 80° C. while slowly adding steam, and the mixture was agitated at high speed (500-3000 rpm). During the agitation, temperature and color of the reactant were observed to check water repellency or texture. The pH of the final product (TALC-LL) was 8.0, and water content was 0.6 wt %. No waste water generated, and total time required for preparation was less than 10 hours.

### Example 4

20 kg of talc (JA-46R, pH 8.2) were introduced into a Henschel mixer, 0.4 kg of N-lauroyl-L-lysine was introduced therein, temperature was elevated to 100° C. while slowly adding steam, and the mixture was agitated at high speed (500-3000 rpm). During the agitation, temperature and color of the reactant were observed to check water repellency or texture. The pH of the final product (TALC-LL) was 8.0, and water content was 0.59 wt %. No waste water generated, and total time required for preparation was less than 10 hours.

### Example 5

20 kg of sericite (B-PAS1000, pH 5.7) were introduced into a Henschel mixer, 0.4 kg of N-lauroyl-L-lysine was introduced therein, temperature was elevated to 80° C. while slowly adding steam, and the mixture was agitated at high speed (500-3000 rpm). During the agitation, temperature and color of the reactant were observed to check water repellency or texture. The pH of the final product (SERI-LL) was 5.5, and water content was 0.6 wt %. No waste water generated, and total time required for preparation was less than 10 hours.

### Example 6

20 kg of sericite (B-PAS1000, pH 5.7) were introduced into a Henschel mixer, 0.4 kg of N-lauroyl-L-lysine was introduced therein, temperature was elevated to 100° C. while slowly adding steam, and the mixture was agitated at high speed (500-3000 rpm). During the agitation, temperature and color of the reactant were observed to check water repellency or texture. The pH of the final product (SERI-LL) was 8.0, and water content was 0.52 wt %. No waste water generated, and total time required for preparation was less than 10 hours.

### Comparative Example

20 kg of mica (MC0800, pH 9.4) were added to a solution containing 154.4 kg of water, 6.417 kg of 20% HCl, and 0.4 kg of CaCl₂, the mixed solution was agitated, and the reactant was mixed with a reactant containing 0.4 kg of N-lauroyl-L-lysine (AMIHOPE-LL, pH 5.4) dissolved in 2.976 kg of 50% NaOH, and the reaction mixture was agitated for 1 hour. The reaction mixture was dehydrated and dried to obtain a final product (MICA-LL). At this time, 160.1 kg of waste water generated, and total time required for preparation was 84 hours.

### Experiment

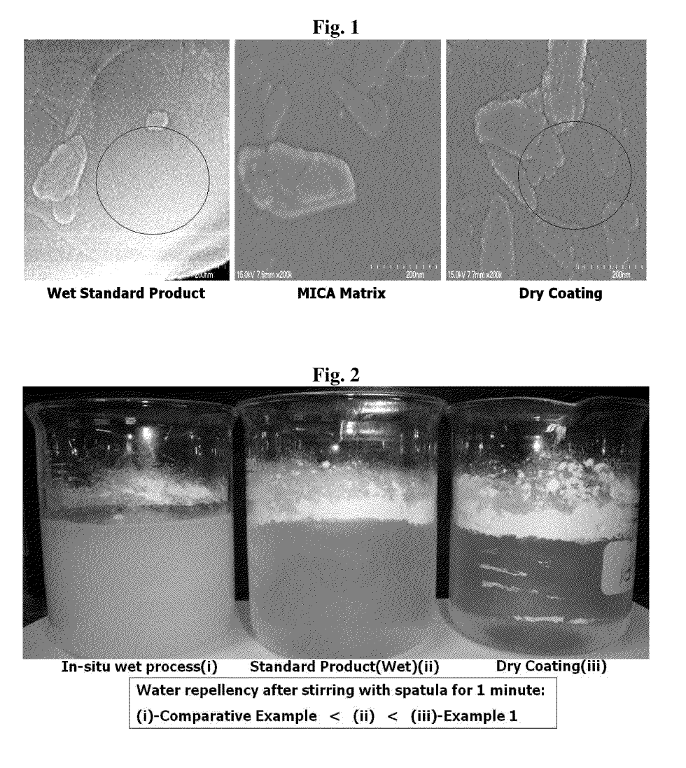

The results of comparing the final products of Example 1 and Comparative Example are summarized in the following Table 1. And, SEM photos of the products prepared thereby are shown in FIG. 1 Water repellency test was conducted by dissolving 10 g of powders respectively prepared in Example 1 and Comparative Example in 100 ml of water and stirring with spatula for 1 minute, and then observing.

TABLE 1

| | | Comparative | |
|---|---|---|---|
| Properties | size | Example | Example 1 |
| External form | Light white powder | Light white | Light white |
| | | powder | powder |
| Middle particle | 15.0-20.0 | 17.50 | 17.02 |
| diameter (μm) | | | |
| Water content (%) | 2.0 max | 0.69 | 0.51 |
| pH | 5.0-9.0 | 5.89 | 6.88 |
| Water | 3.5 or more | 4 | 4.3 |
| repellency (5max) | | | |
| texture | standard | standard | Smoother than |
| | | | standard |

The above Table 1 shows that the modified powder manufactured by a dry process according to the present invention has properties equal to or more excellent than the properties of the powder manufactured by a wet process of the prior art, and the product of the Example of the present invention has more excellent water repellency as shown in FIG. 2. And, it also shows that the product of Example of the present invention has more excellent texture. Accordingly, it is concluded that the modified powder of the present invention is very useful for a cosmetic composition.

The present invention is not limited to the foregoing examples and drawings attached hereto, and various modification or alteration can be made by a person of ordinary skill in the art without departing from the aspect and scope of the present invention as described in the claims appended hereto.

What is claimed is:

1. A method for dry manufacturing of modified powder comprising the steps of:
a) dry mixing powder having hydroxyl group (—OH) at the end and lauroyl lysine in a reactor equipped with an agitator; and
b) agitating the reactor to coat lauroyl lysine on the surface of the powder.

2. The method according to claim 1, wherein the reactor is further equipped with a heater, and in step b), the temperature inside the reactor is elevated.

3. The method according to claim 1, wherein in step a), the amount of lauroyl lysine is 0.5 to 50 parts by weight, based on 100 parts by weight of the powder.

4. The method according to claim 1, wherein in step b), temperature inside the reactor is 80 to 200° C.

5. The method according to claim 1, wherein the powder is selected from the group consisting of titanium oxide particle, zinc oxide particle, silica particle, barium sulfate, silk powder, talc, mica, sericite, kaolin, titanium dioxide coated mica, iron oxide coated mica, chrome oxide coated mica, calcium carbonate, magnesium carbonate, aluminum silicate, magnesium sulfate and the surface-treated powder thereof.

6. The method according to claim 1, wherein in step a), pH inside the reactor is 5˜9.

7. Modified powder manufactured by the method according to claim 1.

8. The modified powder according to claim 7, wherein the water content of the modified powder is less than 2 wt %.

9. A cosmetic composition comprising the modified powder according to claim 7.
